(19) United States
(12) Patent Application Publication
(10) Pub. No.: US 2025/0272269 A1
(43) Pub. Date: Aug. 28, 2025

(54) SERVICE DELIVERY SYSTEM CAPABLE OF IDENTIFYING APPLICATION EXECUTION SYSTEM AS FORWARDING DESTINATION OF CONNECT REQUEST ACCORDING TO CONTENTS OF CONNECT REQUEST AND NON-TRANSITORY COMPUTER-READABLE RECORDING MEDIUM WITH SERVICE DELIVERY PROGRAM STORED THEREON

(71) Applicant: KYOCERA Document Solutions Inc., Osaka (JP)

(72) Inventor: Koki NAKAJIMA, Osaka (JP)

(73) Assignee: KYOCERA Document Solutions Inc., Osaka (JP)

(21) Appl. No.: 19/061,809

(22) Filed: Feb. 24, 2025

(30) Foreign Application Priority Data
Feb. 27, 2024 (JP) 2024-027153

(51) Int. Cl. G06F 16/21

(52) U.S. Cl. CPC G06F 16/214

(57) ABSTRACT

A service delivery system includes a communication device, a storage device, and a controller that functions as a connection controller. The communication device performs communications with an external device. The storage device stores forwarding information that indicates a relationship between contents of a connect request and an application execution system serving as a forwarding destination of the connect request and capable of executing a predetermined application. When receiving the connect request through the communication device, the connection controller identifies the forwarding destination of the 10 received connect request according to the forwarding information and the contents of the connect request and forwards the connect request to the application execution system being the identified forwarding destination.

### INCORPORATION BY REFERENCE

This application claims priority to Japanese Patent Application No. 2024-027153 filed on 27 Feb. 2024, the entire contents of which are incorporated by reference herein.

### BACKGROUND

The present disclosure relates to service delivery systems delivering service to users and non-transitory computer-readable recording media with service delivery programs stored thereon.

Generally, a method for migrating data is known.

### SUMMARY

A technique improved over the aforementioned technique is proposed as one aspect of the present disclosure.

A service delivery system according to an aspect of the present disclosure includes a communication device, a storage device, and a controller. The communication device performs communications with an external device. The storage device stores forwarding information that indicates a relationship between contents of a connect request and an application execution system serving as a forwarding destination of the connect request and capable of executing a predetermined application. The controller includes a processor and functions, through the processor executing a service delivery program, as a connection controller. When receiving the connect request through the communication device, the connection controller identifies the forwarding destination of the received connect request according to the forwarding information and the contents of the connect request and forwards the connect request to the application execution system being the identified forwarding destination.

A non-transitory computer-readable recording medium according to another aspect of the present disclosure stores a service delivery program. When, in a computer including a communication device capable of performing communications with an external device, a storage device that stores forwarding information indicating a relationship between contents of a connect request and an application execution system serving as a forwarding destination of the connect request and capable of executing a predetermined application, and a processor, the processor executes the service delivery program, the service delivery program allows the computer to implement a connection controller. When receiving the connect request through the communication device, the connection controller identifies the forwarding destination of the received connect request according to the forwarding information and the contents of the connect request and forwards the connect request to the application execution system being the identified forwarding destination.

### BRIEF DESCRIPTION OF THE DRAWINGS

FIG. 1 is a block diagram showing an example of a system according to one embodiment of the present disclosure.

FIG. 2 is a view showing an example of a system table.

FIG. 3 is a view showing an example of a forwarding table.

FIG. 4 is a view showing an example of a unidirectional synchronization table.

FIG. 5 is a diagram showing an example of a computer that implements a connection controller.

FIG. 6 is a block diagram showing a system in which a service delivery system includes a single application execution system.

FIG. 7 is a view showing another example of a system table.

FIG. 8 is a view showing another example of a forwarding table.

FIG. 9 is a sequence chart showing an operation of a system when a user terminal is connected to an application execution system.

FIG. 10 is a flowchart showing an operation of the service delivery system shown in FIG. 1 when access information for use in forwarding a connect request is identified.

FIG. 11 is a flowchart showing an operation of the service delivery system shown in FIG. 1 when an application execution system as a destination for migration is added to the service delivery system.

FIG. 12 is a flowchart showing an operation of the service delivery system shown in FIG. 1 in synchronizing a change in a database of the application execution system as a source of migration unidirectionally with a database of the application execution system as a destination for migration.

FIG. 13 is a flowchart showing a method for migration of the application execution system shown in FIG. 1.

FIG. 14 is a sequence chart showing an operation of a system when a user terminal is connected to another application execution system.

FIG. 15 is a view showing still another example of a forwarding table.

### DETAILED DESCRIPTION

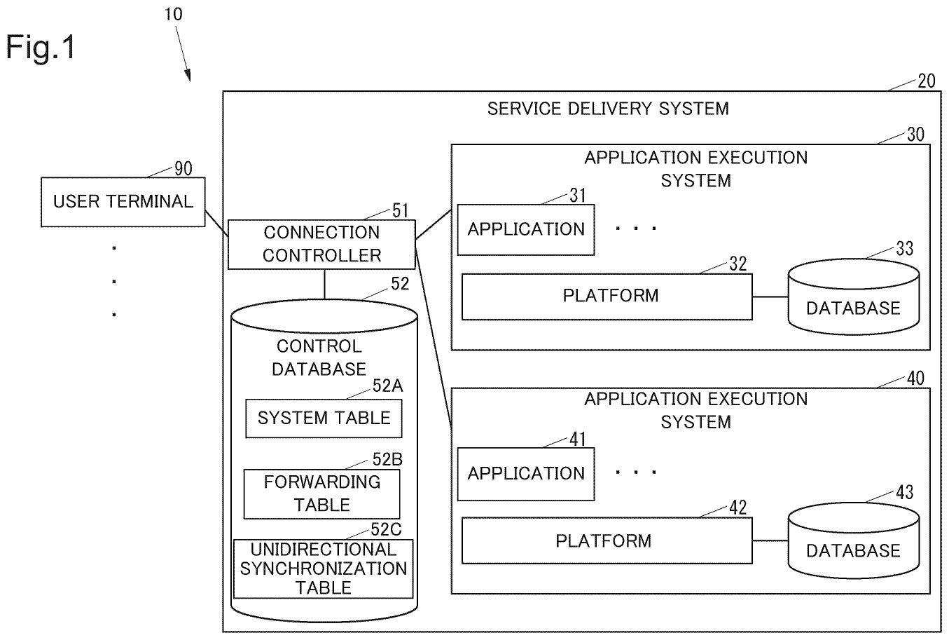

Hereinafter, an embodiment of the present disclosure will be described with reference to the drawings. First, a description will be given of the configuration of a system according to this embodiment. FIG. 1 is a block diagram showing an example of a system 10 according to this embodiment.

As shown in FIG. 1, the system 10 includes a service delivery system 20 for delivering service to users. The service delivery system 20 may be constituted by a single computer, such as a PC (personal computer) or may be constituted by a plurality of computers. The service delivery system 20 may be implemented in a cloud environment.

The service delivery system 20 is capable of including a plurality of application execution systems in which applications for use by a user are to be executed. For example, the service delivery system 20 may include an application execution system 30 and an application execution system 40. The application execution system 30 and the application execution system 40 may be implemented by different computer systems.

The service delivery system 20 includes a connection controller 51 and a control database 52. The connection controller 51 allows a user terminal 90 for use by the user to be connected to either one of the application execution system 30 and the application execution system 40. The control database 52 stores data for use by the connection controller 51.

The application execution system 30 includes an application 31 for use by the user. The application execution system 30 can include, in addition to the application 31, at least one different application for use by the user.

The application execution system 30 includes a platform 32 and a database 33. The platform 32 is a base operating system by which applications, including the application 31, are to be executed. The database 33 stores data for use by the applications, including the application 31, and by the platform 32.

The database 33 contains tenant management data for use in managing tenants. The tenant management data contains, for each tenant, for example, the name of the contractor of the tenant, the name and e-mail address of the manager of the tenant, the names and e-mail addresses of users of the tenant, identification information on an application contracted by the contractor of the tenant, and data for the users of the tenant (hereinafter, referred to as “user data”), such as saved files.

The database 33 contains information on consistency of the tenant management data. The information on consistency of tenant management data contains an index table and reference relationships for easy retrieval of user data.

The application execution system 40 includes an application 41 for use by the user. The application execution system 40 can include, in addition to the application 41, at least one different application for use by the user.

The application execution system 40 includes a platform 42 and a database 43. The platform 42 is a base operating system by which applications, including the application 41, are to be executed. The database 43 stores data for use by the applications, including the application 41, and by the platform 42. Data stored in the database 43 is the same as stored in the database 33.

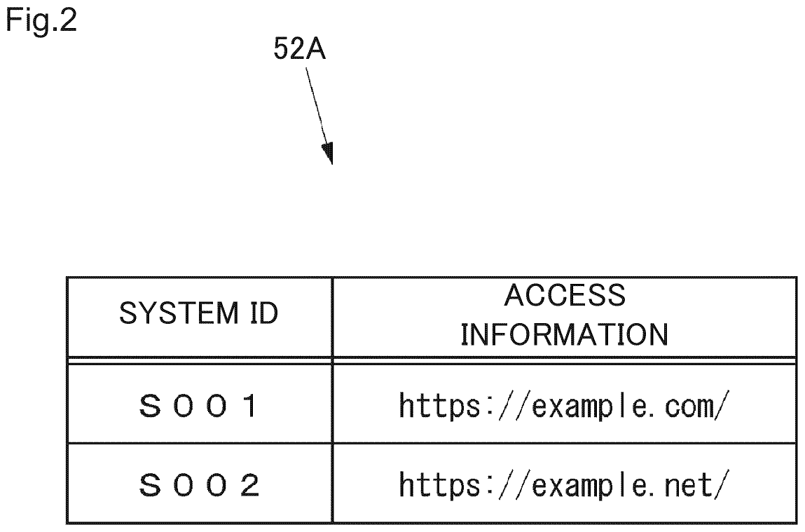

The control database 52 can store a system table 52A indicating information on the application execution systems 30, 40. FIG. 2 is a view showing an example of the system table 52A.

As shown in FIG. 2, the system table 52A contains, as items, a system ID as identification information on each of the application execution systems 30, 40 and access information as information for use in access to each of the application execution systems 30, 40.

The access information is constituted by the URL (uniform resource locator) or IP (internet protocol) address of each of the application execution systems 30, 40.

In the system table 52A shown in FIG. 2, the system ID “S001” of the application execution system 30 is associated with the URL “https://example.com/” of the application execution system 30. Furthermore, the system ID “S002” of the application execution system 40 is associated with the URL “https://example.net/” of the application execution system 40.

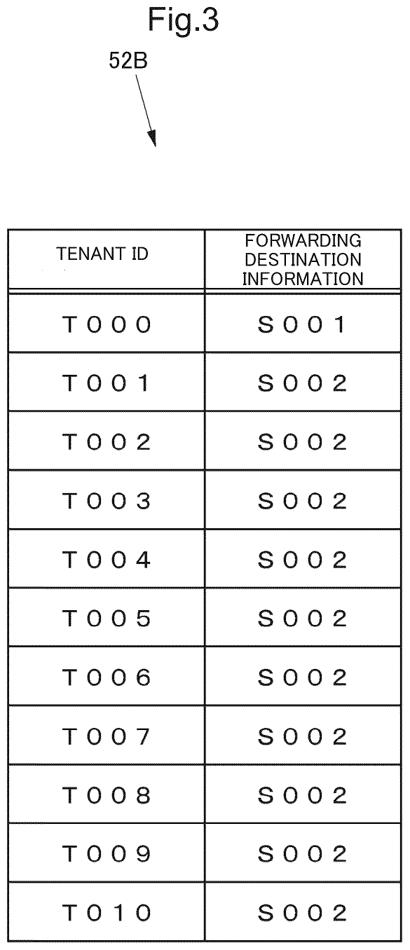

As shown in FIG. 1, the control database 52 can store a forwarding table 52B as forwarding information for use in forwarding a connect request input from the user terminal 90 to the application execution system 30, 40. FIG. 3 is a view showing an example of the forwarding table 52B.

As shown in FIG. 3, the forwarding table 52B contains, as items, a tenant ID as identification information on a tenant to which an individual user belongs, and forwarding destination information indicating a forwarding destination of a connect request input from the user terminal 90 of the user. In other words, the forwarding table 52B is information indicating the relationship between each tenant ID and the forwarding destination of a connect request.

The forwarding destination information is indicated by the system ID of one of the application execution systems 30, 40.

The forwarding table 52B certainly contains a record in which the tenant ID is “T000”. Forwarding destination information in the record in which the tenant ID is “T000” is default forwarding destination information. No tenants having a tenant ID “T000” exist.

In the record containing the tenant ID “T000” in the forwarding table 52B shown in FIG. 3, the tenant ID “T000” is associated with “S001” as forwarding destination information. In the records containing respective tenant IDs “T001” to “T010”, these tenant IDs are associated with “S002” as their forwarding destination information.

As shown in FIG. 1, the control database 52 can store a unidirectional synchronization table 52C for use in synchronizing a change in the database of the application execution system 30, 40 as a source of migration unidirectionally with the database of the application execution system 30, 40 as a destination for migration.

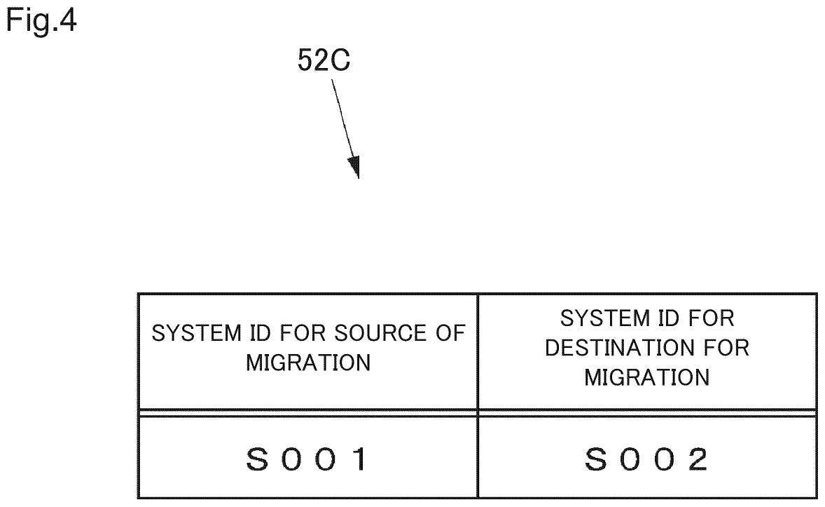

FIG. 4 is a view showing an example of the unidirectional synchronization table 52C. As shown in FIG. 4, the unidirectional synchronization table 52C contains, as items, the system ID of the application execution system 30 as a source of migration and the system ID of the application execution system 40 as a destination for migration.

In the unidirectional synchronization table 52C shown in FIG. 4, the system ID “S001” of the application execution system 30 is indicated as a system ID of an application execution system being a source of migration. The system ID “S002” of the application execution system 40 is indicated as a system ID of an application execution system being a destination for migration.

As shown in FIG. 1, the system 10 can include a user terminal 90 for use by an individual user. The system 10 can include, in addition to the user terminal 90, at least one user terminal for use by the user. The user terminal 90 may be constituted by a computer, such as, for example, a PC or a smartphone.

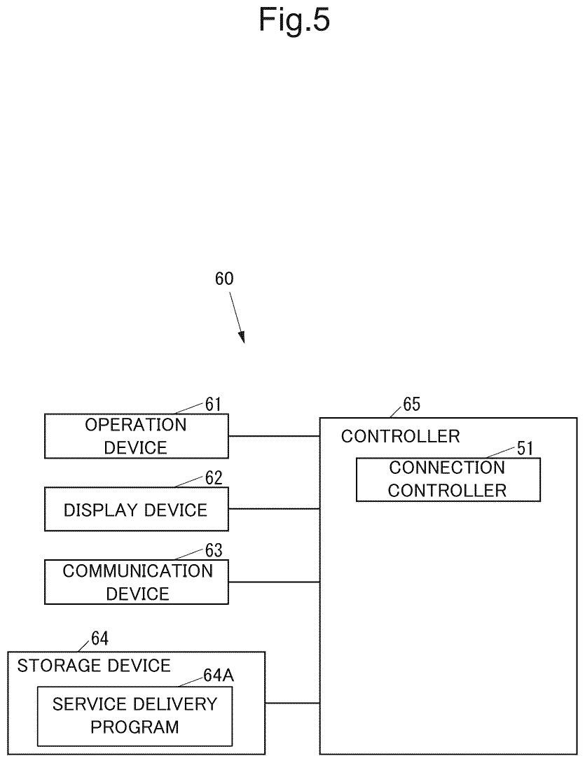

FIG. 5 is a diagram showing an example of a computer 60 that implements the connection controller 51. As shown in FIG. 5, the computer 60 includes an operation device 61, a display device 62, a communication device 63, a storage device 64, and a controller 65.

The operation device 61 is an operation device, such as a keyboard or a mouse, to which various types of operations are to be input. The display device 62 is a display device, such as an LCD (liquid crystal display), on which various types of information are to be displayed.

The communication device 63 is a communication device that performs communications with external devices via a network, such as a LAN (local area network) or the Internet, or directly with external devices by wire or wireless without a network.

The storage device 64 is a non-volatile storage device, such as a semiconductor memory or an HDD (hard disk drive), in which various types of information are to be stored. The controller 65 performs overall control of the computer 60.

The storage device 64 can store a service delivery program 64A for delivering service to users. The service delivery program 64A may be installed on the computer 60, for example, in the manufacturing stage of the computer 60, may be additionally installed on the computer 60 from an external storage medium, such as a USB (universal serial bus) memory, or may be additionally installed on the computer 60 over the network.

The controller 65 includes, for example, a CPU (central processing unit), a ROM (read only memory) that holds programs and various types of data, and a RAM (random access memory) as a memory for use as a working area for the CPU of the controller 65.

The CPU of the controller 65 executes a program stored in the storage device 64 or the ROM of the controller 65. The controller 65 implements the connection controller 51 by executing the service delivery program 64A.

Heretofore, the description has been given of an example where the connection controller 51 is constituted by a single computer 60. However, the connection controller 51 may be constituted by a plurality of computers.

Next, a description will be given of operations of the system 10. First, a description will be given of an operation of the system 10 when the user terminal 90 is connected to the application execution system 30.

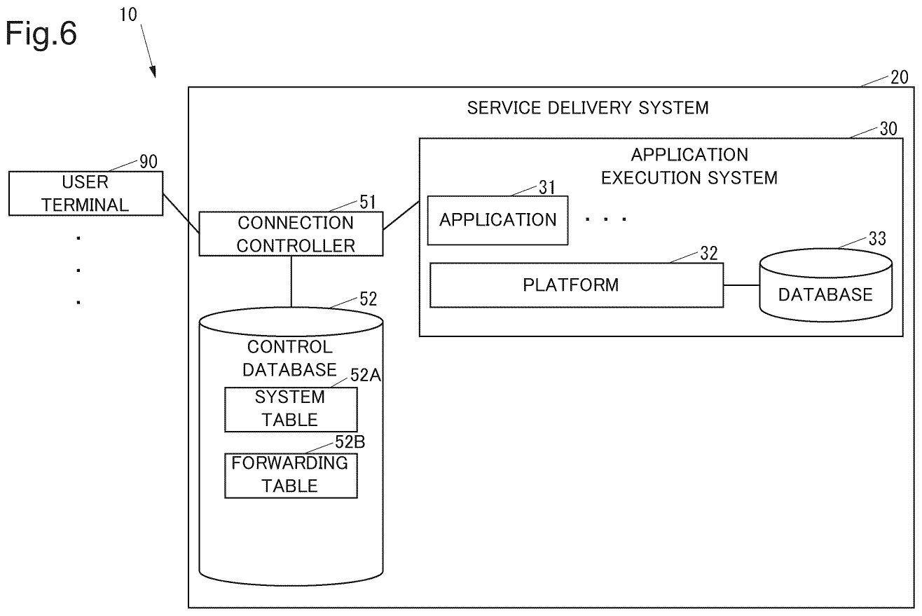

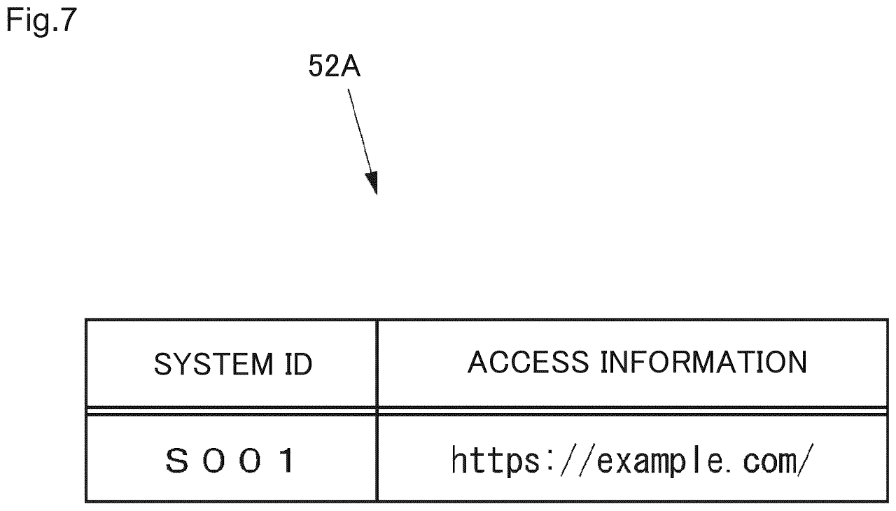

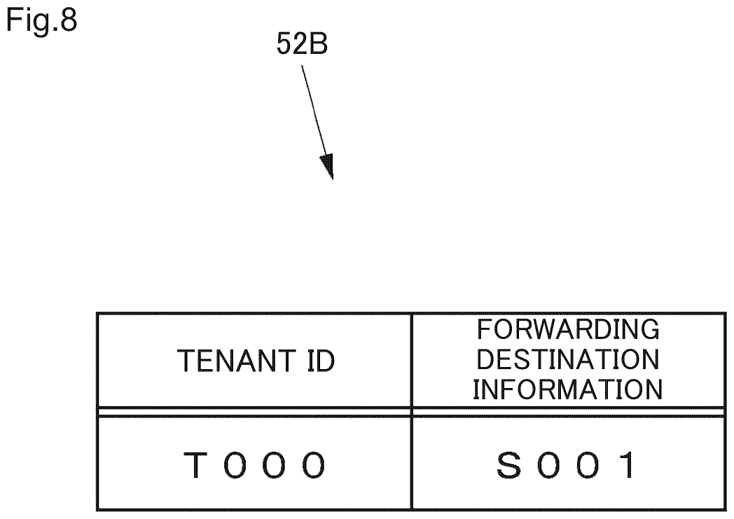

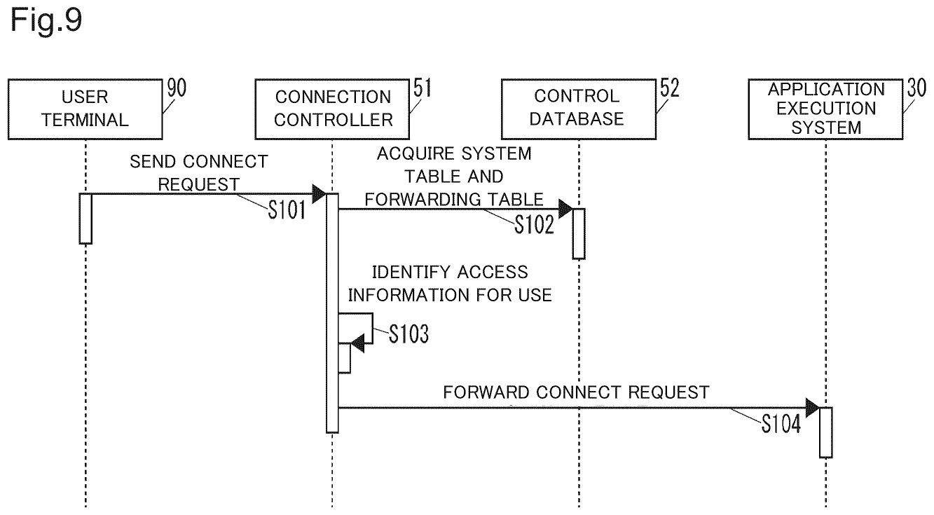

FIG. 6 is a block diagram showing the system 10 in which the service delivery system 20 includes the application execution system 30 only. FIG. 7 is a view showing an example of the system table 52A different from the example shown in FIG. 2. FIG. 8 is a view showing an example of the forwarding table 52B different from the example shown in FIG. 3. FIG. 9 is a sequence chart showing an operation of the system 10 when the user terminal 90 is connected to the application execution system 30.

In the system 10 shown in FIG. 6, the control database 52 holds the system table 52A shown in FIG. 7 and the forwarding table 52B shown in FIG. 8, but does not hold the unidirectional synchronization table 52C.

When in this case the identification information on the tenant to which the user of the user terminal 90 belongs is “T001” and the user instructs the user terminal 90 to connect with the application execution system 30, the user terminal 90 sends to the connection controller 51, as shown in FIG. 9, a connect request to connect with the application execution system 30 (step S101).

In doing so, the user terminal 90 allows the connect request sent to the connection controller 51 in step S101 to contain “T001” indicating the tenant ID of the tenant to which the user of the user terminal 90 belongs.

When receiving the connect request sent from the user terminal 90 in step S101, the connection controller 51 acquires the system table 52A and the forwarding table 52B from the control database 52 and allows these tables to be stored, for example, in the storage device 64 (step S102).

When terminating the processing in step S102, the connection controller 51 identifies access information for use in forwarding the connect request, based on the system table 52A and the forwarding table 52B acquired in step S102 (step S103).

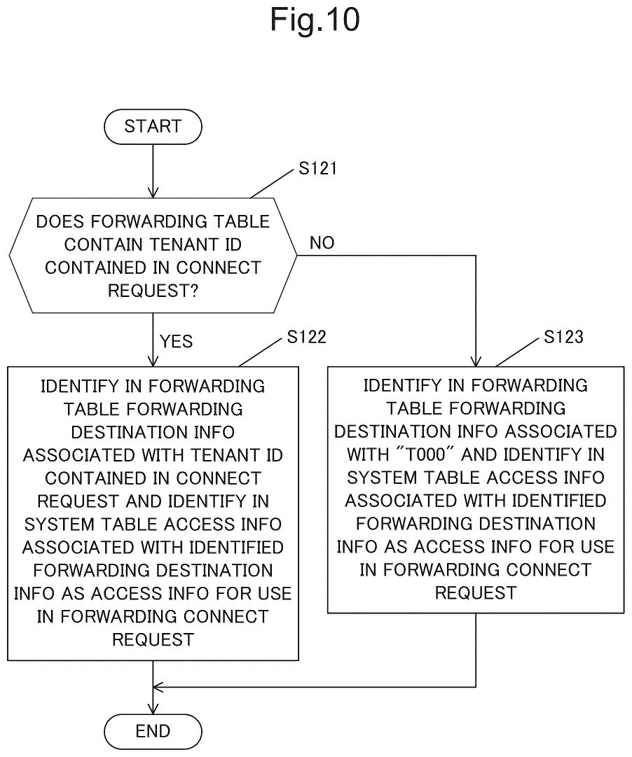

FIG. 10 is a flowchart showing an operation of the service delivery system 20 shown in FIG. 1 when access information for use in forwarding a connect request is identified.

As shown in FIG. 10, the connection controller 51 determines whether or not the tenant ID contained in the connect request sent by the user terminal 90 and received by the connection controller 51 is contained in the forwarding table 52B (step S121).

When determining that the tenant ID contained in the connect request is contained in the forwarding table 52B (YES in step S121), the connection controller 51 identifies, in the forwarding table 52B, forwarding destination information associated with the tenant ID contained in the connect request and identifies, in the system table 52A, access information associated with the identified forwarding destination information as access information for use in forwarding the connect request (step S122).

When determining that the tenant ID contained in the connect request is not contained in the forwarding table 52B (NO in step S121), the connection controller 51 identifies, in the forwarding table 52B, forwarding destination information associated with the tenant ID “T000” and identifies, in the system table 52A, access information associated with the identified forwarding destination information as access information for use in forwarding the connect request (step S123).

When terminating the processing in step S122 or step S123, the connection controller 51 ends the operation shown in FIG. 10.

In the case where the tenant ID of the tenant to which the user of the user terminal 90 belongs is “T001” and the control database 52 holds the system table 52A shown in FIG. 7 and the forwarding table 52B shown in FIG. 8, the connection controller 51 determines in step S121 that “T001” being the tenant ID contained in the connect request is not contained in the forwarding table 52B (NO in step S121).

Subsequently, in step S123, the connection controller 51 identifies, in the forwarding table 52B, “S001” being forwarding destination information associated with the tenant ID “T000” and identifies, in the system table 52A, “https://example.com/” being access information associated with the identified “S001” as access information for use in forwarding the connect request.

As shown in FIG. 9, when terminating the processing in step S103, the connection controller 51 forwards, based on the access information “https://example.com/” identified in step S103, the connect request sent by the user terminal 90 in step S101 and received by the connection controller 51 to the application execution system 30 (step S104).

In this manner, the user terminal 90 is connected to the application execution system 30.

Heretofore, the description has been given of the operation of the system 10 shown in FIG. 6 in the case where the control database 52 holds the system table 52A shown in FIG. 7 and the forwarding table 52B shown in FIG. 8, but does not hold the unidirectional synchronization table 52C and the tenant ID of the tenant to which the user of the user terminal 90 belongs is “T001”.

However, also in the case where, in the system 10 shown in FIG. 6, the control database 52 holds the system table 52A shown in FIG. 7 and the forwarding table 52B shown in FIG. 8, but does not hold the unidirectional synchronization table 52C and the tenant ID of the tenant to which the user of the user terminal 90 belongs is other than “T001”, the user terminal 90 is connected to the application execution system 30 in the same manner.

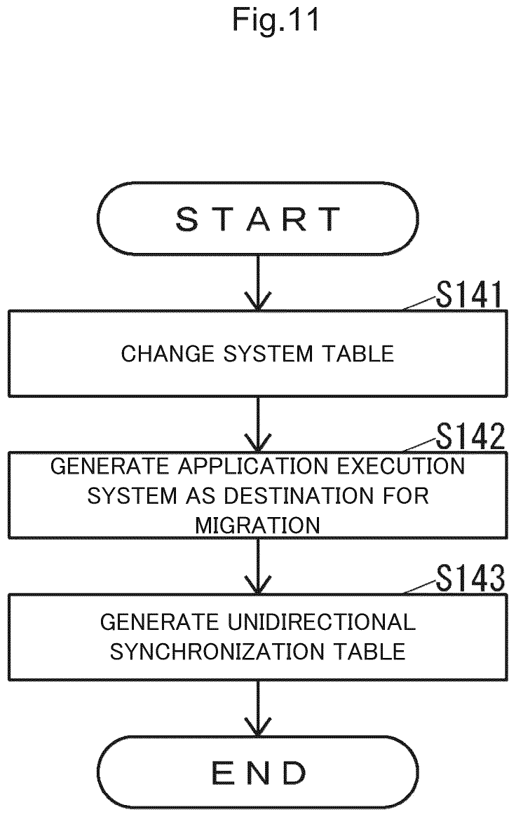

Next, a description will be given of an operation of the service delivery system 20 when the application execution system 40 as a destination for migration is added to the service delivery system 20. FIG. 11 is a flowchart showing an operation of the service delivery system 20 when the application execution system 40 as a destination for migration is added to the service delivery system 20.

When, in the system 10 shown in FIG. 6, the control database 52 holds the system table 52A shown in FIG. 7 and the forwarding table 52B shown in FIG. 8, but does not hold the unidirectional synchronization table 52C and the administrator of the service delivery system 20 instructs the connection controller 51 to add to the service delivery system 20 the application execution system 40 the source of migration of which is the application execution system 30 and which has access information “https://example.net/” and serves as a destination for migration, the connection controller 51 changes, as shown in FIG. 11, the system table 52A shown in FIG. 7 to the system table 52A shown in FIG. 2 (step S141).

When terminating the processing in step S141, the connection controller 51 copies the applications, the platform 32, and the database 33 of the application execution system 30 serving as a source of migration to generate, as shown in FIG. 1, an application execution system 40 serving as a destination for migration (step S142).

When terminating the processing in step S142, the connection controller 51 generates in the control database 52 a unidirectional synchronization table 52C shown in FIG. 4 (step S143) and ends the operation shown in FIG. 11.

Next, a description will be given of an operation of the service delivery system 20 in synchronizing a change in the database 33 of the application execution system 30 as the source of migration unidirectionally with the database 43 of the application execution system 40 as the destination for migration.

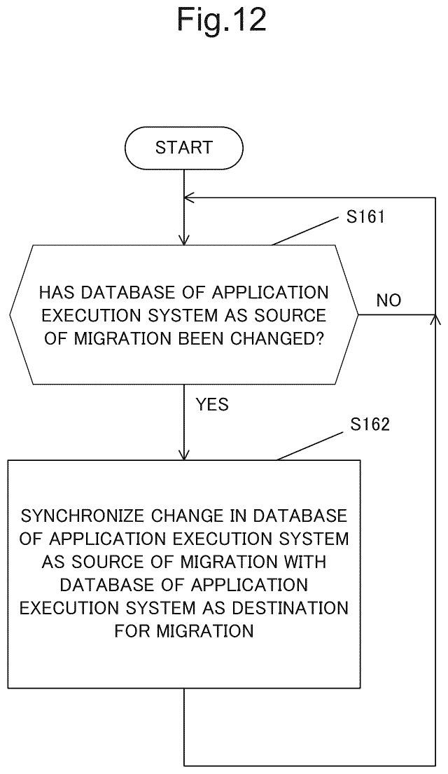

FIG. 12 is a flowchart showing an operation of the service delivery system 20 in synchronizing a change in the database 33 of the application execution system 30 as the source of migration unidirectionally with the database 43 of the application execution system 40 as the destination for migration.

In the case where the control database 52 holds the unidirectional synchronization table 52C, the connection controller 51 executes the operation shown in FIG. 12.

As shown in FIG. 12, until the connection controller 51 determines that the database 33 of the application execution system 30 as the source of migration has been changed, it repeats the processing of determining whether or not the database 33 of the application execution system 30 as the source of migration has been changed (NO in step S161).

For example, when an application of the application execution system 30 has been used by the user terminal 90, data on the application used by the user terminal 90 may be changed in the database 33.

When determining that the database 33 of the application execution system 30 as the source of migration has been changed (YES in step S161), the connection controller 51 synchronizes the change in the database 33 of the application execution system 30 as the source of migration with the database 43 of the application execution system 40 as the destination for migration (step S162) and executes the processing in step S161.

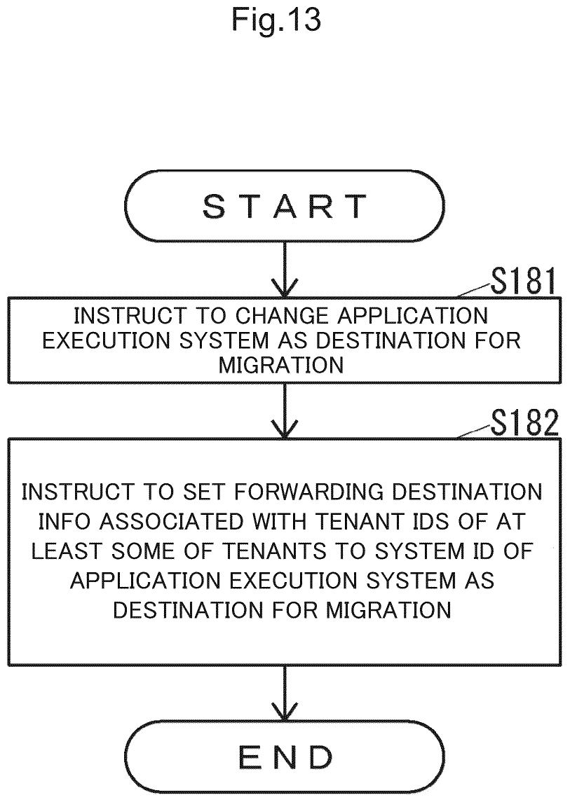

Next, a description will be given of a method for migration of the application execution system 30, 40. FIG. 13 is a flowchart showing a method for migration of the application execution system 30, 40.

As shown in FIG. 13, the administrator of the service delivery system 20 instructs the connection controller 51 to change the applications, the platform 42, and the database 43 of the application execution system 40 as the destination for migration to those serving the purpose of the migration (step S181).

For example, assume that the license model of the application execution system 30 as the source of migration, which has been created for tenants, is either a user-oriented license model or a device-oriented license model. The user-oriented license model is a license model based on the number of users of the application execution system 30 and the contract period for the application execution system 30. The device-oriented license model is a license model based on the number of electronic devices, such as image forming apparatuses, connected to the application execution system 30 and the contract period for the application execution system 30.

When, in this situation, the purpose of the migration is to change the license model for tenants to a subscription-based license model for a specific period, for example, for a month or for a year, the administrator of the service delivery system 20 can instruct the connection controller 51 to change the applications, the platform 42, and the database 43 of the application execution system 40 as the destination for migration to an application execution system for a subscription-based license model.

When receiving the above instruction from the administrator of the service delivery system 20, the connection controller 51 changes the applications, the platform 42, and the database 43 of the application execution system 40 as the destination for migration in response to the received instruction.

The connection controller 51 does not synchronize the change in the database 43 of the application execution system 40 as the destination for migration with the database 33 of the application execution system 30 as the source of migration. Therefore, even when in step S181 the connection controller 51 changes the application execution system 40 as the destination for migration while the user uses the application execution system 30, the service of the application execution system 30 is not shut down.

When the process in step S181 is completed, the administrator of the service delivery system 20 instructs the connection controller 51 to set the forwarding destination information associated with the tenant IDs of at least some of the tenants in the service delivery system 20 to the system ID of the application execution system 40 as the destination for migration (step S182).

When receiving the above instruction from the administrator of the service delivery system 20, the connection controller 51 changes the forwarding table 52B in response to the received instruction. For example, the connection controller 51 changes the forwarding table 52B shown in FIG. 8 to the forwarding table 52B shown in FIG. 3.

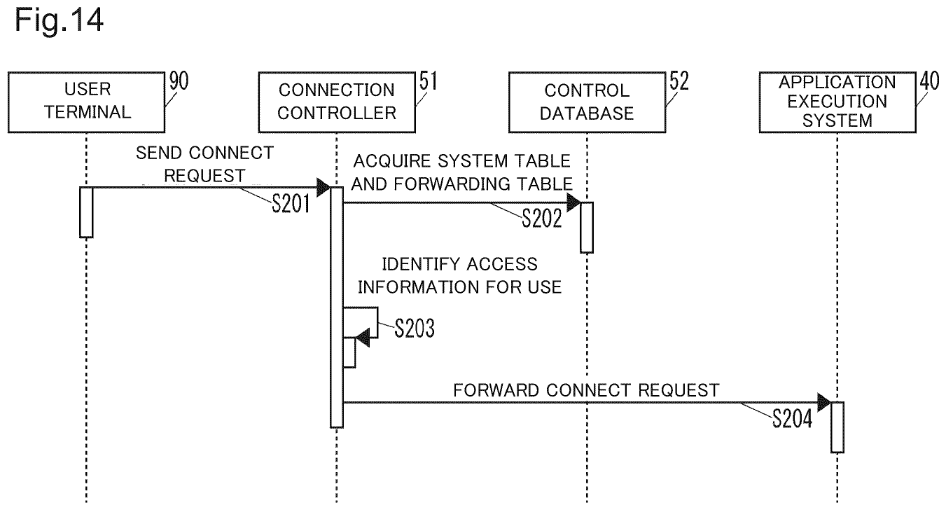

Next, a description will be given of an operation of the system 10 when the user terminal 90 is connected to the application execution system 40. FIG. 14 is a sequence chart showing an operation of the system 10 when the user terminal 90 is connected to the application execution system 40.

Assume that, in the system 10 shown in FIG. 1, the control database 52 holds the system table 52A shown in FIG. 2, the forwarding table 52B shown in FIG. 3, and the unidirectional synchronization table 52C shown in FIG. 4.

When in this case the identification information on the tenant to which the user of the user terminal 90 belongs is “T001” and the user instructs the user terminal 90 to connect with the application execution system 40, the user terminal 90 sends to the connection controller 51, as shown in FIG. 14, a connect request to connect with the application execution system 40 (step S201).

In doing so, the user terminal 90 allows the connect request sent to the connection controller 51 in step S201 to contain “T001” as the tenant ID of the tenant to which the user of the user terminal 90 belongs.

When receiving the connect request sent from the user terminal 90 in step S201, the connection controller 51 acquires the system table 52A and the forwarding table 52B from the control database 52 and allows these tables to be stored, for example, in the storage device 64 (step S202).

When terminating the processing in step S202, the connection controller 51 identifies access information for use in forwarding the connect request, based on the system table 52A and the forwarding table 52B acquired in step S202 (step S203).

In the case where the tenant ID of the tenant to which the user of the user terminal 90 belongs is “T001” and the control database 52 holds the system table 52A shown in FIG. 2 and the forwarding table 52B shown in FIG. 3, the connection controller 51 determines in step S121 (see FIG. 10) that “T001” being the tenant ID contained in the connect request sent by the user terminal 90 and received by the connection controller 51 is contained in the forwarding table 52B.

Subsequently, in step S122 (see FIG. 10), the connection controller 51 identifies, in the forwarding table 52B, “S002” being forwarding destination information associated with the tenant ID “T001”. The connection controller 51 identifies, in the system table 52A, “https://example.net/” being access information associated with the identified “S002” as access information for use in forwarding the connect request.

When terminating the processing in step S203, the connection controller 51 forwards, based on the access information “https://example.net/” identified in step S203, the connect request sent by the user terminal 90 in step S201 and received by the connection controller 51 to the application execution system 40 (step S204).

In this manner, the user terminal 90 is connected to the application execution system 40.

Heretofore, the description has been given of the operation of the system 10 shown in FIG. 1 in the case where the control database 52 holds the system table 52A shown in FIG. 2, the forwarding table 52B shown in FIG. 3, and the unidirectional synchronization table 52C shown in FIG. 4 and the tenant ID of the tenant to which the user of the user terminal 90 belongs is “T001”.

However, also in the case where, in the system 10 shown in FIG. 1, the control database 52 holds the system table 52A shown in FIG. 2, the forwarding table 52B shown in FIG. 3, and the unidirectional synchronization table 52C shown in FIG. 4 and the tenant ID of the tenant to which the user of the user terminal 90 belongs is any one of “T002” to “T010”, the user terminal 90 is connected to the application execution system 40 in the same manner.

On the other hand, in the case where, in the system 10 shown in FIG. 1, the control database 52 holds the system table 52A shown in FIG. 2, the forwarding table 52B shown in FIG. 3, and the unidirectional synchronization table 52C shown in FIG. 4 and the tenant ID of the tenant to which the user of the user terminal 90 belongs is other than “T001” to “T010”, the user terminal 90 is connected to the application execution system 30 as shown in FIG. 9.

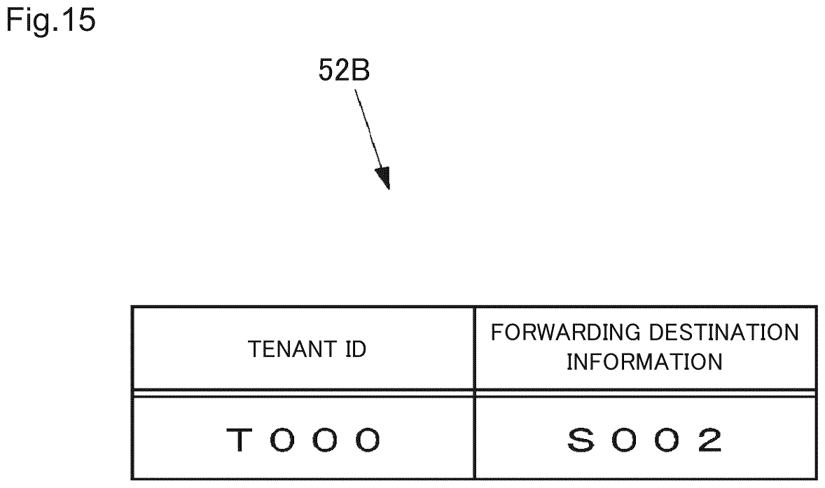

The administrator of the service delivery system 20 monitors, for a specific period, use of the application execution system 40 by the tenants having respective tenant IDs “T001” to “T010” and changes, unless a specific problem occurs, the forwarding table 52B shown in FIG. 3 to the forwarding table 52B shown in FIG. 15.

FIG. 15 is a view showing an example of the forwarding table 52B different from the examples shown in FIGS. 3 and 8.

In the case where, in the system 10 shown in FIG. 1, the control database 52 holds the system table 52A shown in FIG. 2, the forwarding table 52B shown in FIG. 15, and the unidirectional synchronization table 52C shown in FIG. 4, the user terminal 90 is connected to the application execution system 40 regardless of the tenant ID of the tenant to which the user of the user terminal 90 belongs.

A general data migration method has a problem of being unable to perform a migration requiring to change the interpretation of data.

To cope with this problem, in the above embodiment, the service delivery system 20 identifies the application execution system 30, 40 as a forwarding destination of a connect request according to the forwarding table 52B and a tenant ID being the contents of the connect request (step S121 to step S123) and forwards the connect request to the identified application execution system 30, 40 (step S104 or step S204).

Thus, the application execution system 40 different in interpretation of data from the application execution system 30 as a source of migration can be a destination for migration.

As a result, a migration requiring to change the interpretation of data can be performed.

Furthermore, the service delivery system 20 does not synchronize a change in the database 43 of the application execution system 40 as the destination for migration with the database 33 of the application execution system 30 as the source of migration. This enables reduction of the possibility of a change in the database 43 of the application execution system 40 as the destination for migration to have an effect on the use of the user of the application execution system 30 as the source of migration. As a result, the possibility of shutdown of the service of the application execution system 30 in use by the user due to a change in the database 43 of the application execution system 40 as the destination for migration can be reduced.

In addition, in the service delivery system 20, the application execution system 30 as the source of migration and the application execution system 40 as the destination for migration can be implemented by different computer systems. This enables reduction of the possibility of a load due to generation of the application execution system 40 as the destination for migration to have an effect on the use of the user of the application execution system 30 as the source of migration. As a result, the possibility of shutdown of the service of the application execution system 30 in use by the user due to generation of the application execution system 40 as the destination for migration can be reduced.

In the above embodiment, the contents of a connect request for use in identifying the application execution system 30, 40 as a forwarding destination of the connect request are a tenant ID. However, the contents of a connect request for use in identifying the application execution system 30, 40 as a forwarding destination of the connect request may be any information other than the tenant ID.

A non-transitory computer-readable recording medium in which the service delivery program according to the above embodiment is recorded is, for example, a hard disk, a CD-ROM, a DVD-ROM or a semiconductor memory.

While the present disclosure has been described in detail with reference to the embodiments thereof, it would be apparent to those skilled in the art the various changes and modifications may be made therein within the scope defined by the appended claims.

What is claimed is:

1. A service delivery system comprising:
a communication device that performs communications with an external device;
a storage device that stores forwarding information that indicates a relationship between contents of a connect request and an application execution system serving as a forwarding destination of the connect request and capable of executing a predetermined application; and
a controller that includes a processor and functions, through the processor executing a service delivery program, as a connection controller that, upon receipt of the connect request through the communication device, identifies the forwarding destination of the received connect request according to the forwarding information and the contents of the connect request and forwards the connect request to the application execution system being the identified forwarding destination.

2. The service delivery system according to claim 1, wherein the connection controller synchronizes a change in a database of a first application execution system as a source of migration unidirectionally with a database of a second application execution system as a destination for migration.

3. The service delivery system according to claim 1, wherein a first application execution system as a source of migration and a second application execution system as a destination for migration are implemented by different computer systems.

4. The service delivery system according to claim 1, wherein when receiving through the communication device an instruction to add an application execution system to the service delivery system, the connection controller copies an application and a database of a first application execution system as a source of migration to generate a second application execution system as a destination for migration.

5. A non-transitory computer-readable recording medium with a service delivery program stored thereon, wherein when, in a computer comprising a communication device capable of performing communications with an external device, a storage device that stores forwarding information that indicates a relationship between contents of a connect request and an application execution system serving as a forwarding destination of the connect request and capable of executing a predetermined application, and a processor, the processor executes the service delivery program, the service delivery program allows the computer to implement a connection controller that, upon receipt of the connect request through the communication device, identifies the forwarding destination of the received connect request according to the forwarding information and the contents of the connect request and forwards the connect request to the application execution system being the identified forwarding destination.
